(19) United States
(12) Patent Application Publication
(10) Pub. No.: US 2025/0353153 A1
(43) Pub. Date: Nov. 20, 2025

(54) PLIERS, AND METHOD FOR PRESSING A WIRE END SLEEVE

(71) Applicant: GUSTAV KLAUKE GMBH, Remscheid (DE)

(72) Inventors: Andreas LEHR, Neuss (DE); Egbert FRENKEN, Heinsberg (DE); Christian ZUPP

(73) Assignee: GUSTAV KLAUKE GMBH, Remscheid (DE)

(21) Appl. No.: 18/869,751

(22) PCT Filed: Jun. 7, 2023
(86) PCT No.: PCT/EP2023/065168

§ 371 Date: Nov. 26, 2024

(30) Foreign Application Priority Data
Jun. 10, 2022 (DE) 10 2022 114 698.7
Oct. 21, 2022 (DE) 10 2022 127 882.4

(51) Int. Cl. B25B 27/14; B25B 7/12

(52) U.S. Cl. CPC B25B 27/146; B25B 7/12

(57) ABSTRACT

Pliers including plier handles and two plier jaws which are movable between an open position and a closed position. The plier jaws are connected to one another in an articulated manner by first and second joints, and are connected to the plier handles in an articulated manner by third and fourth joints. The plier handles are connected directly to one another in an articulated manner by a fifth joint between the third and the fourth joints. An additional plier handle is provided, which in the open position extends in a pivoting direction of the plier handles between the plier handles. The additional plier handle extends starting at one of the plier jaws and is rigidly connected to this plier jaw for pivoting purposes.

### FIELD OF TECHNOLOGY

What is described and explained are pliers comprising two plier handles and two plier jaws, wherein the plier handles are connected to the plier jaws for moving the plier jaws between an open position and a closed position, wherein one plier jaw has a handle-side end assigned to the respective plier handle and an opposite end, wherein the plier jaws are further connected to one another in an articulated manner between the ends in a first and a second joint, and are connected to the plier handles in an articulated manner on the handle-side ends in a third and a fourth joint, wherein the plier handles are furthermore connected directly to one another in an articulated manner in a fifth joint formed between the third and the fourth joint, wherein an additional plier handle is further provided, which in the open position extends in a pivoting direction of the plier handles between the plier handles.

What is further described and explained is an arrangement having a first and a second pressing jaw, wherein the pressing jaws are formed to move relative to one another in a movement direction, wherein each pressing jaw has ribs, wherein the ribs are formed with a longitudinal extension transversely to the movement direction of the pressing jaws, and wherein entrance openings are left between adjacent ribs, wherein, in the course of a pressing, the ribs of the first pressing jaw are formed to enter into the entrance openings of the second pressing jaw, and the ribs of the second pressing jaw are formed to enter into the entrance openings of the first pressing jaw, wherein the first and the second pressing jaw form a pressing mouth with an essentially rectangular opening contour, which is formed by means of free outer edges of the ribs, wherein the ribs of the first pressing jaw, which form a handle of the rectangular contour, further form corners of the points of intersection, which form opening contours with assigned ribs of the second pressing jaw, which points of intersection move during a pressing.

Lastly, what is also described and explained is a method for pressing a wire end sleeve on a cable by using pliers comprising two plier handles, as they are described above and below, for example also by using the arrangement of the pressing jaws, as it is described above and below.

### PRIOR ART

Pliers comprising two plier handles, as described above, are known, for example, from KR 10 2009 0 081 087 A.

With regard to the prior art, reference is to further be made for instance to US 109 192 A. The pliers known from this have only two joints. One plier handle is formed in a shortened manner. To increase the lever force, a cam lever is provided, which acts with a cam that slides along the shortened plier handle in the course of the actuation. The cam lever is connected to the other plier handle only via an angular part, which protrudes at a right angle on the other plier handle and which additionally also has an obliquely directed stabilizing part.

With regard to pliers, as they are described above, in more general terms, reference is to also be made for instance to US 2018/0040998 A1.

With regard to the arrangement of two pressing jaws, reference is to initially be made to WO 2022/029320A2. It is known from this to provide an additional pressing part, which covers the point of intersection of the ribs inwards, in a corner region of the rectangular opening contour. Reference is to further be made to US 10 615 558 B2, from which it is known for a hexagon opening contour to form an elongate protrusion contour, which is formed in one piece in the direction of a stringing-together of the ribs, in a region of the ribs between two corner regions.

### SUMMARY OF THE DESCRIPTION

Based on the initially mentioned prior art, it is the object with regard to the pliers comprising two plier handles to specify such pliers, which can be handled in an advantageous manner with regard to the additional plier handle.

This object is initially and essentially solved in that the additional plier handle extends starting at one of the plier jaws and is rigidly connected to this plier jaw for pivoting purposes.

A favorable initial position can be attained thereby with respect to the plier handle, by means of which at least a start of the pressing is initially performed, for example with one-handed handling, by encompassing the plier handle and the additional plier handle. Due to the fact that the additional plier handle is connected directly to the plier jaw, a virtually identical lever arm results on the plier handle as on the additional plier handle in the region of the hand performing the handling. A comparatively small total length of the pliers, measured from a free end of the plier jaws to a free end of the plier handles, can nevertheless be attained in a favorable manner in the closed state of the pliers. The additional plier handle can be attained in a favorable manner even in the case of wide to completely open pliers.

With regard to the arrangement of the first and second pressing jaw, it is the object based on the mentioned prior art to be able to perform a favorable pressing, in particular with regard to a pressing of wire end sleeves on a cable.

This object is initially and essentially solved in that a tooth-like protrusion, which protrudes to a center of the opening contour and the extension of which in the longitudinal direction of the rib and to the center of the opening contour in each case corresponds to one third or less of the free length of the rib between the points of intersection or a point of intersection and a corner formation at the start of a pressing process, is formed on an outer edge of a rib, approximately in the center between a point of intersection and a corner formation.

In the case of a protrusion formed in this way, it has been shown in an advantageous manner that in particular during the pressing of a sleeve, but also during the pressing of any other object, an advantageous first impact on the pressed part can be attained, which, in the case of, for example, a sleeve applied to a further object, such as a cable, can already lead to a first connection between the objects when the plier mouth that has the pressing jaws is also only closed slightly at first.

With regard to the method, the object is initially and essentially solved in that a pressing up to a first folding of the wire end sleeve is initially performed with one hand by using the additional plier handle, and that the pressing is subsequently completed by using both plier handles.

The pressing until a first folding of the wire end sleeve leads to an already reliable holding of the cable in the wire end sleeve, so that a user of the pliers is initially freed from a required holding of the cable with the other hand—compared to the one hand, by means of which the pliers are initially actuated with the help of the additional plier handle—so that the user can then engage with both plier handles simultaneously and can bring the pressing to an end with more force.

Further features are explained below, and in the figure description often in their preferred assignment to one or several of the generally described solutions or to further features. However, they can also be relevant in an assignment to only individual features, which have already been described and/or to the respective further described feature or in each case independently. The described features and the or the features, which will be explained further below, can in particular also be realized individually or repeatedly or combined as a whole on an object, such as in particular pliers.

With regard to the additional plier handle, it can be provided that the latter corresponds to at least one hand width, thus, for example, 8 to 15 cm in length or that it has approximately half of a free length compared to the free length of one or both of the plier handles.

The additional plier handle can furthermore at least also be articulated on the third joint. It can thus pivot with the plier jaw about this joint. The additional plier handle can furthermore be connected to the plier jaw, for example, to at least one further fixed point outside of a joint.

The additional plier handle can be arranged and formed in relation to the plier handles to which it is assigned directly due to the plier jaw, to which it is connected, in such a way that it can traverse the plier handle in a closed position of the pliers or is in a position on top of this plier handle, respectively. The pliers and the additional plier handle can likewise be formed and arranged, for example, so that the fifth joint can be traversed, optionally in the region of a protrusion region of the additional plier handle. For this purpose, the additional plier handle can further preferably be formed in an essentially plate-like manner in a cross-section. It is thus a flat part. A dimension of the additional plier handle based on a cross section outside, i.e. based on the extension towards the free end on the other side of an optionally provided protrusion region, is, for example, larger, approximately by 1.2-times or more, than a dimension perpendicular thereto. It can further correspond to approximately 1.8- to 2.2-times, furthermore for example to approximately 2-times. The arrangement on a plier jaw can optionally also be attained in order to attain the mentioned traversability and option for being positioned one on top of the other, by means of spacers, then provided in the direction of a joint axis, between the additional plier handle and the plier jaw, which is fastened.

The additional plier handle can also be connected to the plier handles only by the jaws, and thereby via a rotary joint. In further detail, the additional plier handle can be connected to the one plier handle via a joint connecting the plier jaw, to which it is fastened, to the plier handle, but additionally to the further plier handle via a further, fifth joint, which directly connects the plier handles.

The pliers are formed, for example, as crimping pliers, further for example for crimping wire end sleeves to cables, which are then stripped in this regard, for example in the region, in which the wire end sleeve is applied.

A plier mouth of these pliers can be formed by a pressing jaw, which is in each case received in the plier jaw, in particular a pressing jaw, as it is described below in even more detail. Such a pressing jaw, however, can also be part of the plier jaw, without being exchangeable.

These pressing jaws can form several individual pressing openings. This, for example, in the sense that different sizes result, so that wire end sleeves of different sizes or other parts of different sizes can be pressed.

With regard to the arrangement of the first and second pressing jaws, it can be provided that the protrusion has two flanks, which run straight, converging towards the center of the opening contours. A tip protruding into the interior of the opening contour thus results.

These flanks can draw an acute angle of between 60 and 30 degrees with a part of the contour running perpendicular to the part of the rectangular contour of this rib, which runs straight.

With regard to its free end, which protrudes into the center of the opening contour, the flanks can merge into one another, for example in a rounded manner.

### BRIEF DESCRIPTION OF THE DRAWINGS

The described solution is furthermore explained below on the basis of the enclosed drawing, which, however, only represents exemplary embodiments, in which:

FIG. 1 shows pliers with an additional plier handle in the closed position;

FIG. 1a a cross-section according to the line Ia-Ia in FIG. 1 of the additional pliers handle;

FIG. 2 shows a section through the object according to FIG. 1, cut along the line XII-XII in FIG. 1;

FIG. 3 shows the pliers according to FIG. 1 in an open position with inserted cable and wire end sleeve;

FIG. 4 shows the pliers according to FIG. 3 at the start of a pressing;

FIG. 5 shows the pliers according to FIG. 4 after continuing the pressing;

FIG. 6 shows the pliers according to FIG. 5 after continuing the pressing by using both plier handles;

FIG. 7 shows the pliers according to FIG. 6 after completion of the pressing in the closed position;

FIG. 8 shows an arrangement of two pressing jaws in the closed position;

FIG. 9 shows the arrangement according to FIG. 8 in an open position, in perspective;

FIG. 10 shows a pressing of a wire end sleeve on a cable with plier jaws according to FIG. 8 or FIG. 9, respectively, at the start of a pressing;

FIG. 11 shows an illustration according to FIG. 10, after continuing the pressing;

FIG. 12 shows an illustration according to FIG. 10 or FIG. 11, respectively, after completion of the pressing; and

FIG. 13 shows a wire end sleeve pressed on a cable when pressing has been completed.

### DESCRIPTION OF THE EMBODIMENTS

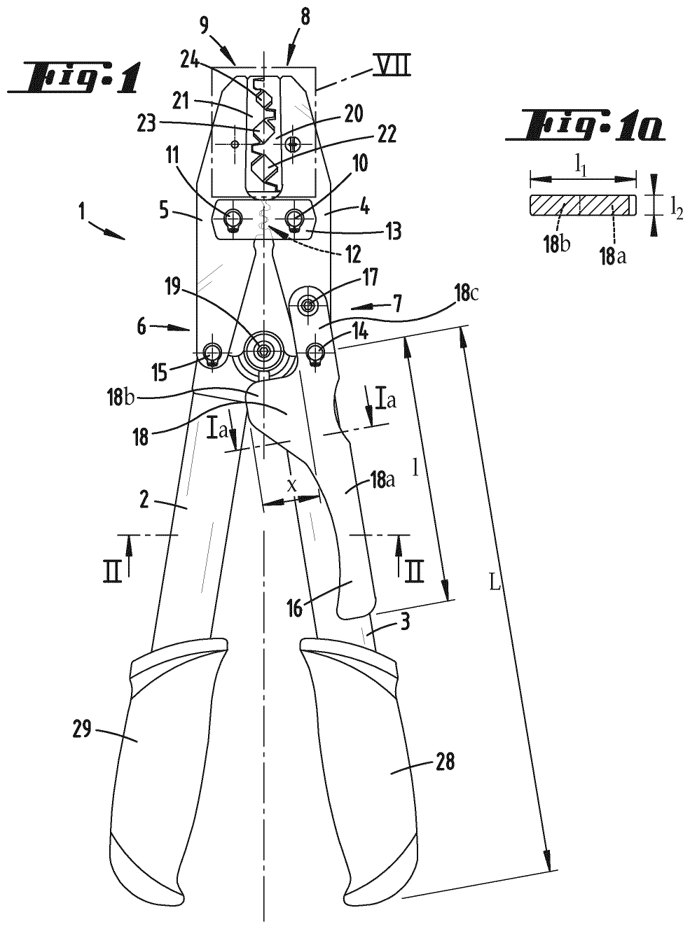

What is illustrated and described, initially with reference to FIG. 1, are pliers 1 comprising two plier handles 2, 3 and two plier jaws 4, 5.

The plier jaws 4, 5 have a handle-side end 6, 7 and an opposite, free end 8, 9.

The plier jaws 4, 5 are pivotably connected to one another between the respective ends 7 and 8 or 6 and 9, respectively, in an articulated connection by a first joint 10 and a second joint 11 which may be provided by respective pivot shafts that extend therethrough. The first joint 10 and the second joint 11 can also be replaced by a single joint. The single joint can then be provided, for example, instead of a roller region 12, which will be explained below, and in this region.

As provided in the case of f the exemplary embodiment, the plier jaws 4, 5 can support one another even further in a roller region 12, as it is suggested in a dashed manner in FIG. 1. The plier jaws 4, 5 can furthermore be connected to one another by means of one or two tabs 13. Tabs 13 can be provided on both sides with respect to flat sides of the plier jaws 4, 5 which face each other. The roller region 12 can be realized by respective curved surfaces of the pliers jaws 4, 5 abuting each other. The roller region 12 can also be realized, as in the shown embodiment, by two gear sections meshing which each other.

The plier jaws 4, 5 can be—and are in the shown embodiment—connected to the plier handles 2, 3 in an articulated connection via a third joint 14 and a fourth joint 15 which may be provided by respective pivot shafts that extend therethrough. The plier handles 2, 3 can be connected directly to one another in a fifth joint 19 which may be a pivot shaft that extends therethrough and provides an articulated connection. The fifth joint 19 is provided between the third and fourth joints 14, 15.

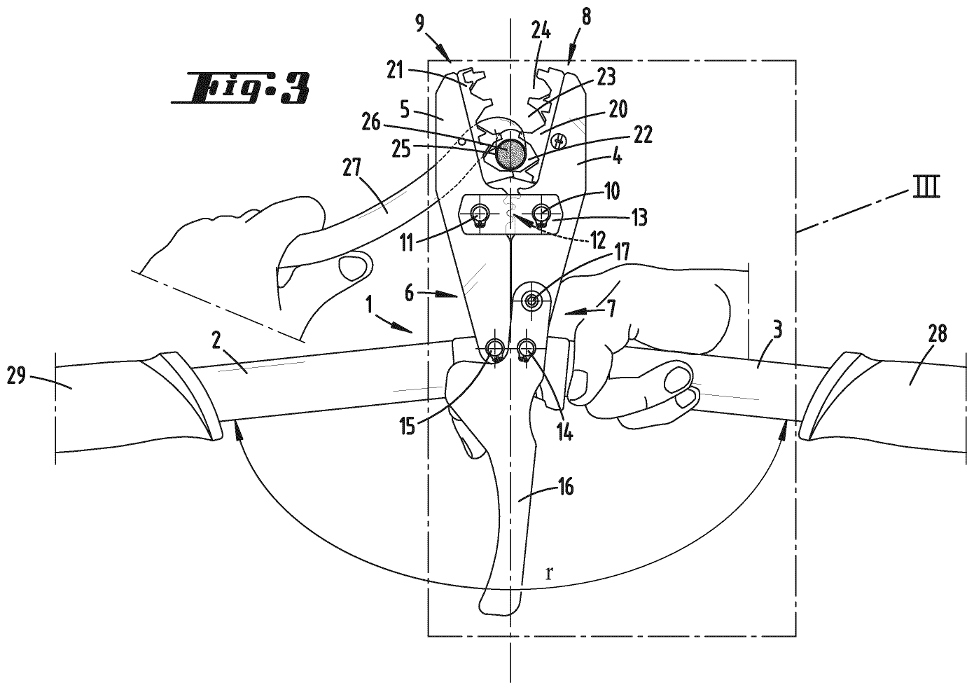

An additional plier handle 16 can further be provided, which, in an open position of the pliers 1, see for instance FIG. 3, extends in a pivoting direction r

between the plier handles 2, 3. In an initial state, see FIG. 1, or in an end state, see FIG. 7, when the pliers 1 are closed, the additional plier handle 16 as shown, can also extend completely or partially in overlapping with one of the plier handles 2, 3, as illustrated.

In an initial state (see FIG. 1), or in an end state (see FIG. 7), when the pliers 1 are closed, the additional plier handle 16 as shown, can also extend completely or partially in overlapping with one of the plier handles 2, 3, as illustrated.

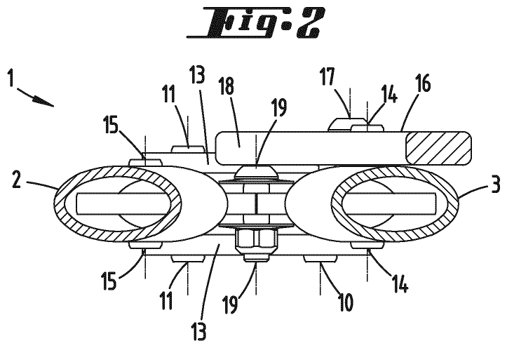

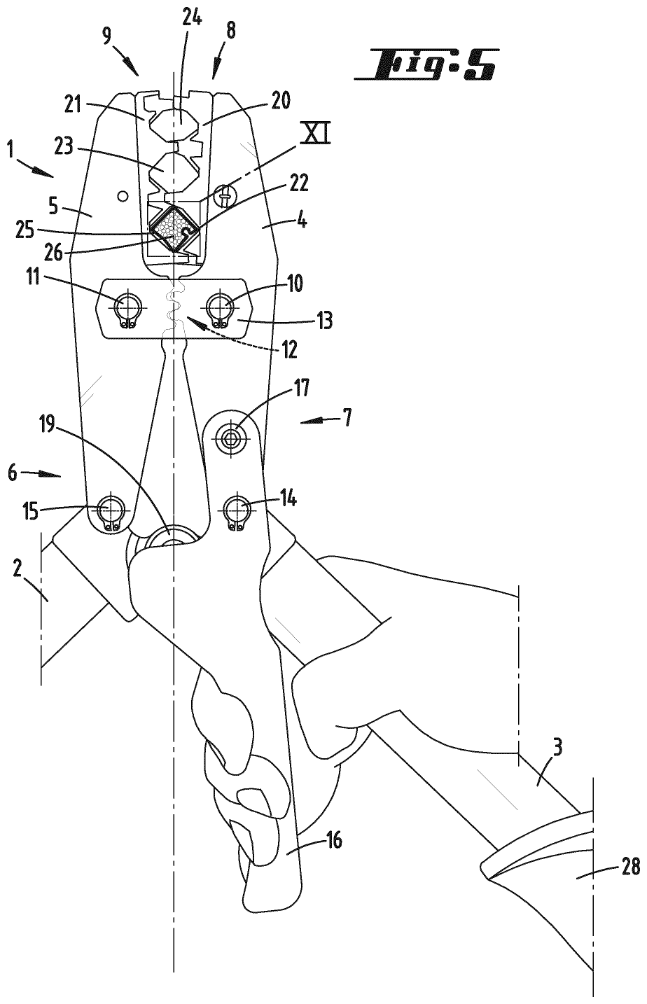

The additional plier handle 16 can be fixedly provided on the plier jaw 4 and the plier handles 3, 4 pivot relative to the additional plier handle 16. As shown in FIG. 2, the additional plier handle 16 extends in a region and thus also pivots in this region, which is present above a grip part of the plier handles 3, 4, especially of the plier handle 3. The additional plier handle can partly extend over the plier handle 3 in the not yet completely closed state of the pliers according to FIG. 5, but does extend at least in the closed position according to FIG. 1 over the plier handle 3. In this respect, the additional plier handle 16 is also formed, for example, in an essentially plate-like manner. One can distinguish as to this plier handle 16 a main regions 18a and protrusion section 18b. The protrusion section 18b is nearer to the pliers mouths than the main section 18a. The main section 18a serves as the handle section of the plier handle 16. The additional plier handle 16 has a main section 18a which has a generally rectangular cross-section and further has, for example, a protrusion section 18b which extends from a side of the main section 18a in the pivoting direction r between the ends thereof as further described herein. The main section 18a and the protrusion section 18b can be sections of a same plate like-manner part. The same applies to a section 18c. A length l1 in the pivoting direction r of the cross-section of the main section 18a can be approximately 1.5-times or more up to approximately 3-times or 10-times the dimension transversely to the pivoting direction r of the additional plier handle 16. The extension in the movement direction r can be yet again significantly larger with respect to the dimension transversely to the pivoting direction r in the protrusion section 18b, which can generally have an identical rectangular profile, which also merges into the protrusion section 18b in a co-planar manner.

The form of the additional plier handle 16 in an essentially plate-like manner means that there is a generally rectangular cross-section as shown in FIG. 1a. This cross-section has a length l1 extending essentially in the pivoting direction r and a lengths l2 extending at a right angle to the pivoting direction r.

The rectangular profile of the additional plier handle 16 can be as such the same over the length l. The length 1 can be 8 to 15 cm.

However, in order to have the two different sections, the main section 18a and the protrusion section 18b, the length l1 can be different over the length l of the additional plier handle 16.

Whereas generally a length of the cross-section in the pivoting direction r can be 1.5 times or more up to approximately 3 times or 10 the length 12, in the protrusion section 18b the relation is higher than in a main section 18a. In the main section 18a it can be e.g. between 1.5 times to 3 times whereas it can be in the protrusion section 18b up to 10 times.

The additional plier handle 16 can be rigidly connected to one of the plier jaws, in the case of the exemplary embodiment is the connection to the plier jaw 4. The connection is such that the additional plier handle 16 may move or pivot with the plier jaw, in the given case the plier jaw 4.

In the case of the exemplary embodiment and preferably, the additional plier handle 16 can be connected, as shown, in the drawings, to the third joint 14. The joint 14 make consist of a joint axis which may extend through the section 18c of the additional plier handle 16. The section 18c may have generally a cross-section described concerning the section 18a. The section 18c is preferably nearer to the plier mouth than the protrusion section 18b. The joint 14 and/or the joint axis respectively, may extend through main section 18a or in the given case specifically through the section 18c of the additional plier handle 16. To allow the plier jaw 4 to pivot relative to the additional plier handle 16, the additional plier handle 16 is fixedly coupled to the plier jaw 4 at connecting region 17.

The additional plier handle 16 is independent of whether by means of one of the sections 18a, 18b and 18c is used, preferably fixedly coupled to the plier jaw 4 at connection region 17. Both the connection by the third joint 14 as well as the connection in region 17 serve together for the fact that the additional plier handle 16 is fixedly coupled to the plier jaw 4.

The connection region 17 can be formed outside of one of the joints 10, 14, for example between these two joints 10, 14. The connection region 17 can also be provided by an axis passing through the additional plier handle 16 and the plier jaw 4; a riveting or welding, for example, can also be present.

Alternatively thereto, the additional plier handle 16 can be formed in one piece with the plier jaw 4 or even with the plier jaw 5. The plier jaw 4 or 5 can also be comprised of several plate parts located one on top of the other. The additional plier handle 16 can thereby be formed, for example, on (only) one of the plate parts, in extension of this plate part, alternatively also as further plate part. The optionally further plate part can also be attached at a distance from the jaw part, optionally a jaw plate part, via one or several spacers, in order to provide for the traversing over a plier handle in the described manner.

The additional plier handle 16 has the already mentioned free length l which is defined from the third joint 14, for example a geometric joint axis of this joint, to the free end of the additional plier handle 16, which length l can be one third to two third, preferably half of the free length L of the plier handle 3 or in the given case plier handle 2. The free length l can be, for example, one third of the free length L or, in the case of a long plier handle 3, one fourth of the free length L. The free length l may also be corresponding intermediate values.

The additional plier handle 16 can also be formed in a joint-free and/or connection-free manner across the entire free length l, with the exception of the region on the joint 14. The additional plier handle 16 preferably does not have a functional part or a functional region, which would cooperate with one of the other plier handles 3, 4 over this free length l.

The additional plier handle 16 can further have the protrusion section 18b, which extends in the pivoting direction r, starting at a straight continuation over the connecting region 17 and the third joint 14, towards the other plier handle 2. Viewed in the direction towards the free end of the additional plier handle 16, the protrusion section 18b starts below the third joint 14 and has a dimension x, starting at an outer edge of the section 18a or 18c, the outer edge facing the other pliers handle. The dimension X corresponds approximately to the distance between the third joint 14 and the fifth joint 19 or goes beyond that. In the case of the exemplary embodiment, the extension of the protrusion section 18b also goes beyond that, approximately by one fourth or more of the mentioned distance to the fifth joint 19.

When the plier jaws 4, 5 are open, see FIG. 3, this protrusion section 18b can be such that it covers the fifth joint 19, which can also contribute to the safety.

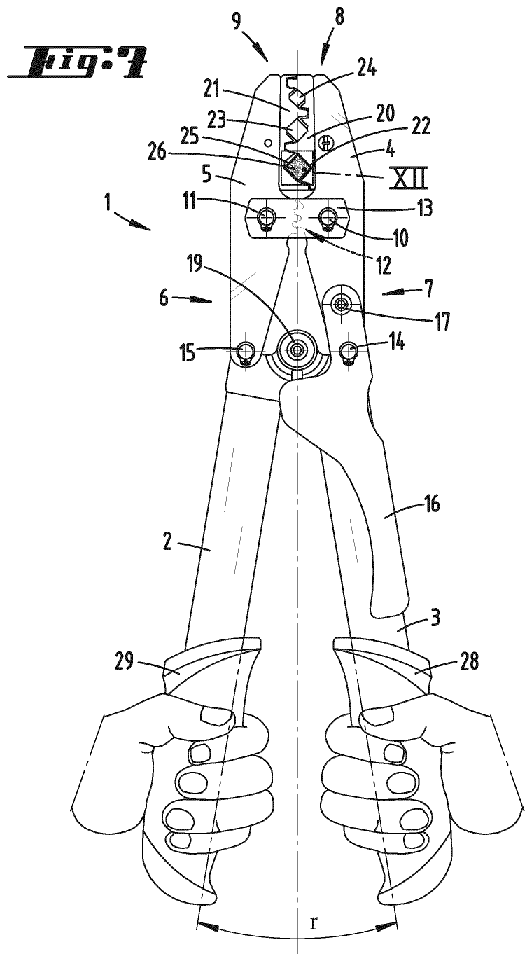

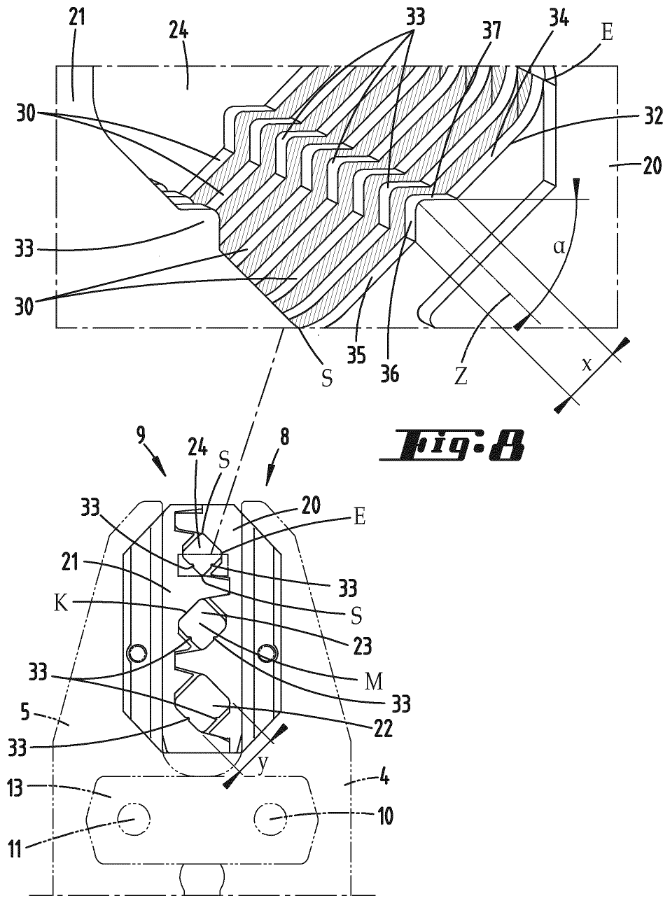

In the case of the exemplary embodiment, a pressing jaw 20 or 21, respectively, as illustrated in further detail in FIGS. 8 and 9, are respectively received in the plier jaws 4, 5.

These pressing jaws 20, 21 can form several individual pressing openings 22, 23, 24. A largest individual pressing opening 22 of each pressing jaws 20, 21 can be proximate to the first joint 10 or proximate to the second joint 11, and one or two further individual pressing openings 23, 24, each providing a smaller opening cross-section, can be formed towards the free ends of the plier jaws 4, 5. Two corresponding pressing openings of the jaws do form a pressing mouth. The pressing jaws as such do form between them a pliers mouth.

A pressing, for example of a wire end sleeve 25 on a free, stripped end 26 of a cable 27, can be performed in such a way, with reference to FIG. 3, that the stripped end 26 is inserted with the attached wire end sleeve 25 into an individual set of pressing openings, here for example the individual set of pressing openings 22, with the plier jaws 4, 5 in the open position. The cable 27 is initially held there by the user with one hand, see FIG. 3. With the other hand of the user, the user can grasp the respective plier handle, here the plier handle 3 and simultaneously reach the additional plier handle 16 with the fingers of that same hand, see FIG. 3. By pulling on the additional plier handle 16 the user can effect a first pressing of the wire and sleeve 25 on the end 26 of the cable 27.

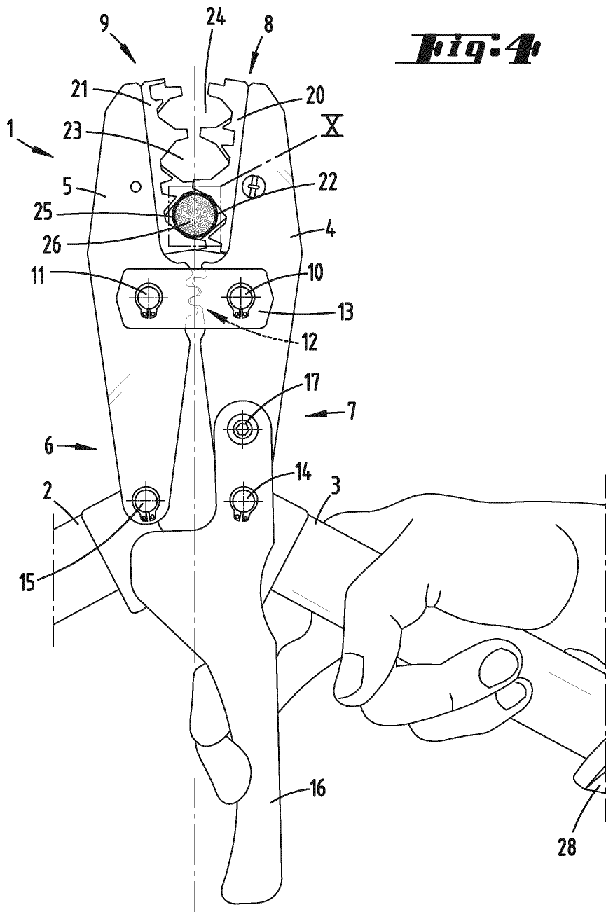

Thereafter with such first pressing of the wire end sleeve 25 onto the stripped end 26 of the cable 27, the handle-side end 7 of the plier jaw 4 moves outwards by moving away from the plier jaw 5 which is moved along simultaneously due to the articulated connection provided by the joints 14 and 15. This effected by pulling the additional plier handle 16 further towards the plier handle 3, see FIG. 4. The plier handle 3 pivots thereby towards the other plier handle 2. An angular orientation between the additional plier handle 16 and the plier handle 3 changes simultaneously and becomes smaller.

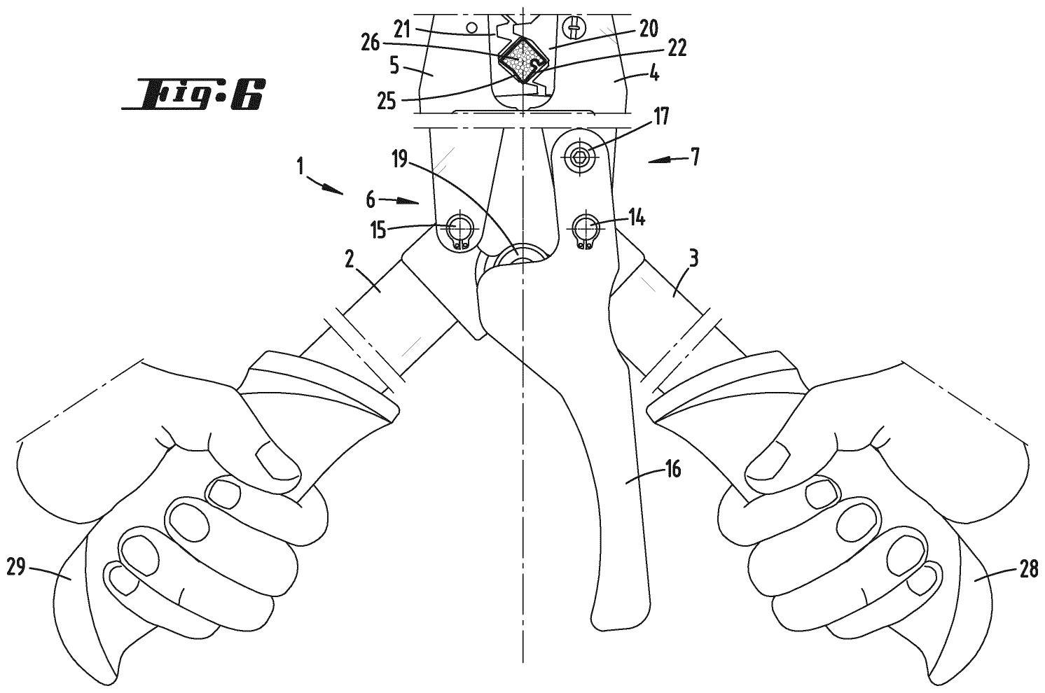

FIG. 4 does illustrate a further step of the initially one-handed pressing. This is done until approximately a state according to FIG. 5 is reached. Thereafter, as shown in FIG. 6, the user subsequently grasps the grip regions 28, 29 of the plier handles 2, 3 with both hands, and the pressing is completed by applying an even higher force, until the closed position of the plier jaws 4, 5 is reached as shown in FIG. 7.

With reference to FIGS. 8 and 9, the first and second pressing jaws 20 and 21 are explained in further detail.

The pressing jaws 20, 21 are designed to move relative to one another in the movement or pivoting direction r.

Each of the pressing jaws 20, 21 has a plurality of ribs 30, which are formed with a longitudinal extension 13 transversely to the movement direction r. At a pressing, the ribs do form a generally rectangular contour, having four legs extending essentially at right angles to each other.

Entrance openings 31 are provided between adjacent ribs 30. In the course of a pressing, the ribs 30 of the first pressing jaw 20 can enter into the entrance openings 31 of the second pressing jaw 21 and vice versa. In the closed position of the plier jaws 4, 5, as it is illustrated, for instance, in FIG. 7 or also FIG. 8, the first and the second pressing jaws 20, 21 form an essentially rectangular opening contour K, which is formed by means of free outer edges of the ribs 30. In the closed position of FIG. 7 or 8, respectively, these ribs 30 are moved one on top of the other in the viewing direction in the depth direction of the opening contour K at points of intersection S. In the course of a pressing, the points of intersection S wander inwards until an end contour, for instance according to FIGS. 7 and 8, is reached.

A tooth-like protrusion 33 protruding towards a center M of the opening contour K can be formed on an outer edge 32 of a rib 30, approximately in the center thereof, based on the mentioned points of intersection S or based on a point of intersection S, respectively, and a corner forming E of the opening contour K. An extension x of the tooth-like protrusion 33 in the longitudinal direction of the rib 30 and also in the direction towards the center M of the opening contour K can in each case correspond to one third or less of a free length y of the rib 30. The free length is the length the contour is straight, not considering the protrusion 33, see e.g. FIG. 9. For example, the extension x can be identical in the direction towards the center M and in the longitudinal direction of a rib The extension x of the protrusion, can correspond to approximately one tenth to three tenths, for example approximately 1.5 tenth of such free length.

A section 34 or 35, respectively, of the rib 30, which forms a straight part of the rectangular opening contour K, can adjoin on both sides of the tooth-like protrusion 33.

The tooth-like protrusion 33 can have, for example, two flanks 36, 37, which run straight and converge towards the center M of the opening contour K. They form a tip.

With a perpendicular line Z, which is perpendicular to the part of the rectangular opening contour K of this rib 30 that runs straight, the flanks 36, 37 can further for example draw an acute angle a of between, for example, 30 and 60 degrees, for example an angle x of approximately 45 degrees. That is, the flanks 36, 37 can define an included angle of between, for example, 60 and 120 degrees.

The flanks 36 and 37 can merge into one another in a rounded manner on the end side, the tip, on their free end assigned to the center M.

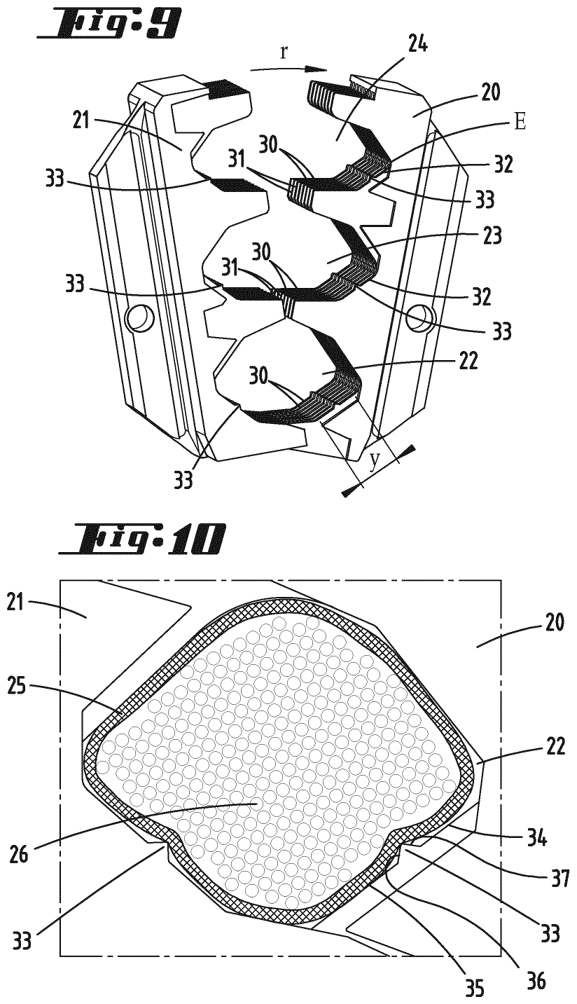

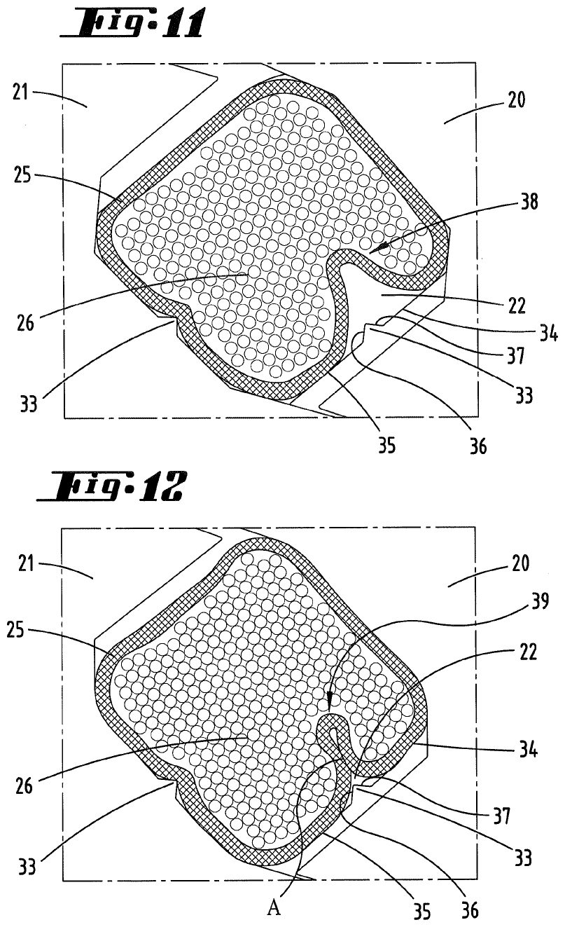

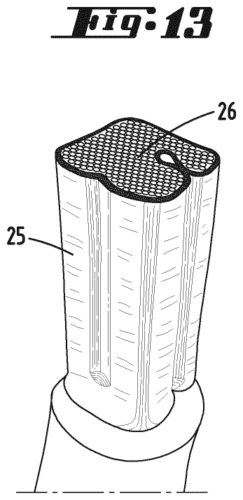

In the case of a (only) small extension x, found in this respect, of the tooth-like protrusion 33 in the direction towards the center M of the respective pressing opening 22, the effect results due to the one or the several tooth-like protrusions 33 that shortly after the start of the pressing, see the sequence of FIGS. 10 and 11, the wire end sleeves 25 have a fold 38, which, see FIG. 12, can further develop all the way to an abutment A, see FIG. 12. This tooth-like protrusion 33 can also have the same relative dimensions based on the straight free outer edge of the assigned rib 30, as explained above.

If a further tooth-like protrusion 33 is formed, as in the case of the exemplary embodiment of FIGS. 10 to 12, also on an outer edge of a further rib 30, which, in the case of the viewed opening contour, extend, for example approximately at a right angle to the initially viewed outer edge of the first rib 30, a corresponding bulge 38 can also result there, see FIGS. 11 and 12.

With the extension x, which can also be found empirically in the individual case, of the tooth-like protrusion 33 with respect to the protruding thereof towards the center M of the opening contour K, it can be attained in a surprising manner that even though the fold 39 is present on the completed pressed part, virtually no impressions of the tooth-like protrusion 33 or protrusions 33 have resulted on the pressed part because a corresponding detachment from the tooth-like protrusions 33 has taken place promptly in the course of the pressing.

### LIST OF REFERENCE NUMERALS

1 pliers
2 plier handle
3 plier handle
4 plier jaw
5 plier jaw
6 handle-side end
7 handle-side end
8 free end
9 free end
10 first joint
11 second joint
12 roller region
13 tab
14 third joint
15 fourth joint
16 additional plier handle
17 connecting region
18a main section
18b protrusion section
18c section
19 fifth joint
20 pressing jaw
21 pressing jaw
22 individual pressing opening
23 individual pressing opening
24 individual pressing opening
25 wire end sleeve
26 stripped end
27 cable
28 grip region
29 grip region
30 rib
31 entrance opening
32 outer edge
33 tooth-like protrusion
34 section
35 section
36 converging flank
37 converging flank
38 bulge
39 fold
l free length of 16
r movement direction
X extension
Y free length of rib
A abutment
E corner formation
K opening contour
L free length of plier handle 2 or plier handle 3
M center
S point of intersection
Z perpendicular line
αangle

1. Pliers comprising:
first and second plier handles;
first and second plier jaws, wherein the plier handles are connected to the plier jaws and are configured to move the plier jaws between an open position and a closed position, wherein one plier jaw has a handle-side end assigned to the respective plier handle and an opposite end, wherein the plier jaws are further connected to one another in an articulated manner between the ends in a first joint and a second joint, and are connected to the plier handles in an articulated manner on the handle-side ends in a third and a fourth joint wherein the plier handles are furthermore connected directly to one another in an articulated manner in a fifth joint formed between the third and the fourth joint; and an additional plier handle extends starting at one the first plier jaw and is rigidly connected to the first plier jaw, wherein the additional plier handle in the open position extends in a pivoting direction of the plier handles between the plier handles.

2. The pliers according to claim 1, wherein the additional plier handle has approximately half of a free length compared to the free length of the first plier handle.

3. The pliers according to claim 1, wherein the additional plier handle is articulated on the third joint.

4. The pliers according to claim 1, characterized in that wherein the additional plier handle can be moved all the way into an overlap position with the first plier handle.

5. Pliers The pliers according to claim 1, wherein the pliers are formed as crimping pliers.

6. The pliers according to claim 1, wherein a plier mouth is formed by first and second pressing jaws, wherein the first and second pressing jaws are received in the respective first and second plier jaw.

7. The pliers according to claim 6, wherein the pressing jaws form several individual pressing openings.

8. An arrangement comprising:
a first pressing jaw and a second pressing jaw, wherein the pressing jaws move relative to one another in a movement direction, wherein each pressing jaw has ribs, formed with a longitudinal extension transversely to the movement direction of the pressing jaws, and wherein entrance openings are provided between adjacent ribs, wherein, in the course of a pressing, the ribs of the first pressing jaw are formed to enter into the entrance openings of the second pressing jaw, providing points of intersection thereby, and the ribs of the second pressing jaw are formed to enter into the entrance openings of the first pressing jaw, wherein the first and the second pressing jaw form a pressing mouth with a generally rectangular opening contour in a closed position, the opening contour being formed by free outer edges of the ribs, wherein the ribs of the first pressing jaw, which form a leg of the rectangular contour, further form corners formed by the points of intersection, with assigned ribs of the second pressing jaw, which points of intersection move during a pressing; and
a tooth-like protrusion, which protrudes to a center of the opening contour and an extension of which in the longitudinal direction of the rib and to the center of the opening contour in each case corresponds to one third or less of a free length of the rib at the start of a pressing process, is formed on an outer edge of the rib approximately in the center between two points of intersection, which this rib forms.

9. The arrangement according to claim 8, wherein a section of the rib, which forms a straight part of the rectangular contour, adjoins the tooth-like protrusion on both sides.

10. The arrangement according to claim 8, wherein the tooth-like protrusion has two flanks, which run straight and which converge towards the centers of the opening contours.

11. The arrangement according to claim 10, wherein the flanks draw an acute angle of between 90 and 30 degrees with a perpendicular line to the part of the rectangular opening contour, which runs straight.

12. The arrangement according to claim 10, wherein the flanks merge into one another in a rounded manner.

13. A method for pressing a wire end sleeve on a cable comprising:
providing pliers comprising two plier handles and two plier jaws, the plier handles are connected to the plier jaws and are configured to move the plier jaws between an open position and a closed position, wherein one plier jaw has a handle-side end assigned to the respective plier handle and an opposite end, wherein the plier jaws are further connected to one another in an articulated manner between the ends in a first joint and a second joint, and are connected to the plier handles in an articulated manner on the handle-side ends in a third and a fourth joint, wherein the plier handles are furthermore connected directly to one another in an articulated manner in a fifth joint formed between the third and the fourth joint, wherein an additional plier handle is further provided, which in the open position extends in a pivoting direction of the plier handles between the plier handles, wherein further the additional plier handle extends starting at one of the plier jaws and is rigidly connected to this plier jaw;
pressing to a first folding of the wire end sleeve is initially performed with one hand by using the additional plier handle, and
pressing is subsequently completed by using both plier handles.
